(19) United States
(12) Patent Application Publication
(10) Pub. No.: US 2015/0211474 A1
(43) Pub. Date: Jul. 30, 2015

(54) MULTI-STRIKE ENGINE IGNITION TECHNIQUES

(71) Applicants: Adam Eckardt, Shelby Township, MI (US); Adam Remesz, Auburn Hills, MI (US); Lakshmi Ganapathy, Troy, MI (US); Monroe Goble, JR., Wyandotte, MI (US)

(72) Inventors: Adam Eckardt, Shelby Township, MI (US); Adam Remesz, Auburn Hills, MI (US); Lakshmi Ganapathy, Troy, MI (US); Monroe Goble, JR., Wyandotte, MI (US)

(21) Appl. No.: 14/163,634

(22) Filed: Jan. 24, 2014

(51) Int. Cl. F02P 15/08; F02P 5/04

(52) U.S. Cl. CPC F02P 15/08; F02P 5/04

(57) ABSTRACT

An optimized multi-strike ignition technique for an internal combustion engine includes, in one exemplary implementation, determining (i) a number of ignition coil re-strikes, (ii) a re-dwell percentage for ignition coil re-strikes, and (iii) a time between ignition coil re-strikes based on total exhaust gas recirculation (EGR) and engine speed. The optimized multi-strike engine ignition technique also includes controlling multi-strike engine ignition by controlling a sparking system of the engine based on the determined multi-strike parameters.

### FIELD

The present disclosure relates generally to internal combustion engines and, more particularly, to multi-strike engine ignition techniques.

### BACKGROUND

Internal combustion engines combust an air/fuel mixture within cylinders to drive pistons that rotatably turn a crankshaft to generate drive torque. The air/fuel mixture is ignited by a spark generated by an inductive and/or capacitive discharge (CD) sparking system including, but not limited to, spark plugs, ignition coils, low-side insulated bi-polar transistors (IGBTs) or Darlington transistors, and a controller. Typically, sparking systems are commanded to generate a single ignition event per combustion event, which is also known as “conventional” or “single strike” engine ignition. Alternatively, the sparking system is commanded to generate two or more ignition events during a single combustion event, which is also known as “multi-strike” engine ignition.

Multi-strike engine ignition can improve combustion stability, which results in a decreased coefficient of variation (COV) of indicated mean effective pressure (IMEP). More particularly, multi-strike engine ignition can provide for faster and/or normalized flame kernel to achieve a desired burn time, for decreased COV of IMEP values and, as a result, decreased brake specific fuel consumption (BSFC). However, optimal multi-strike parameters per ignition event often vary based on various engine operating conditions. Furthermore, high energy and high secondary currents supplied to the spark plug gap could cause high spark plug erosion, which decreases spark plug life and thereby increase vehicle and warranty costs and increase the total cost of ownership of the vehicle.

### SUMMARY

In one form, a method is provided and, in one exemplary implementation, includes determining, at a controller for an internal combustion engine, the controller having one or more processors, an amount of exhaust gas recirculation (EGR) for the engine and a speed of the engine. The method includes determining, at the controller, a number of ignition coil re-strikes per cylinder combustion event for multi-strike engine ignition based on the amount of EGR and the engine speed. The method includes determining, at the controller, a re-dwell percentage for ignition coil re-strikes based on the amount of EGR and the engine speed. The method includes determining, at the controller, a timing between the ignition coil re-strikes based on the amount of EGR and the engine speed. The method also includes controlling, by the controller, multi-strike engine ignition by controlling a sparking system of the engine based on (i) the number of ignition coil re-strikes, (ii) the re-dwell percentage, and (iii) the timing between the ignition coil re-strikes.

In another form, an exemplary engine system is presented in accordance with the teachings of the present disclosure. The engine system, in one exemplary implementation, includes an internal combustion engine and a controller. The engine has a plurality of cylinders configured to combust an air/fuel mixture to generate drive torque. The controller is configured to determine an amount of EGR for the engine and a speed of the engine. The controller is configured to determine a number of re-strikes of ignition coils per cylinder combustion event for multi-strike engine ignition based on the amount of EGR and the engine speed. The controller is configured to determine a re-dwell percentage for ignition coil re-strikes based on the amount of EGR and the engine speed. The controller is configured to determine a timing between the ignition coil re-strikes based on the amount of EGR and the engine speed. The controller is also configured to control multi-strike engine ignition by controlling a sparking system based on (i) the number of ignition coil re-strikes, (ii) the re-dwell percentage, and (iii) the timing between the ignition coil re-strikes.

Further areas of applicability of the teachings of the present disclosure will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present disclosure are intended to be within the scope of the present disclosure.

### BRIEF DESCRIPTION OF THE DRAWINGS

FIG. 1 is an example diagram of an engine system according to the principles of the present disclosure;

FIG. 2 is an example functional block diagram of a controller of the engine system according to the principles of the present disclosure;

FIG. 3 is an example graph of multi-strike ignition for a cylinder combustion event according to the principles of the present disclosure; and

FIG. 4 is an example flow diagram of a multi-strike engine ignition method according to the principles of the present disclosure.

### DESCRIPTION

As previously mentioned, an optimal number of ignition coil re-strikes per cylinder combustion event often varies based on various engine operating conditions. One engine operating condition that affects the optimal number of re-strikes is exhaust gas recirculation (EGR). Furthermore, high currents at the spark plugs often cause spark plug erosion, which decreases spark plug life and thereby increase vehicle costs and potentially decrease engine performance.

Accordingly, multi-strike engine ignition techniques are presented. In one example, the techniques are implemented using low-impedance, fast discharging/recharging ignition coils to increase fuel economy without significantly eroding spark plugs. Lower peak secondary currents are used by using multiple strikes per cylinder combustion event. Further, precise multi-strike control is used to increase fuel economy. In one exemplary implementation, an optimized multi-strike engine ignition technique determines (i) a number of re-strikes, (ii) a re-dwell percentage, and (iii) a time between re-strikes based on total EGR and engine speed.

In another implementation, the multi-strike engine ignition techniques of the present disclosure are utilized during periods of high internal dilution. The term “internal dilution” refers to an air charge for a cylinder being diluted by exhaust gas. Alternatively, this is referred to as internal EGR. During transient periods when the engine speed and/or load change by a large amount, e.g., due to varying transmission shift points and/or variable valve timing (VVT) overlap, the actual camshaft position lags the desired camshaft position. This difference between the actual camshaft position and the desired camshaft position causes high internal dilution. In some cases, this high internal dilution negatively affects engine performance and/or fuel economy. Thus, the multi-strike engine ignition techniques of the present disclosure are activated during these transient periods to compensate for the high internal dilution, thereby increasing engine performance and/or fuel economy.

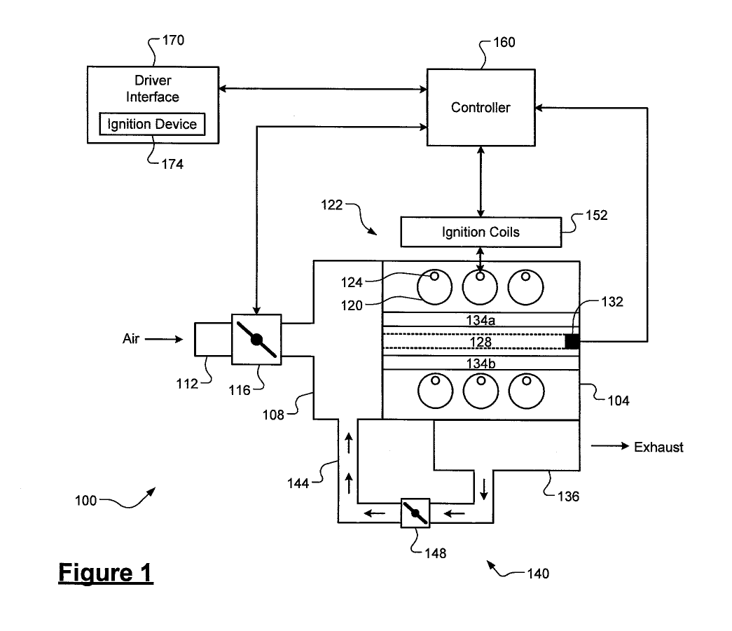

Referring now to FIG. 1, an example diagram of an engine system 100 is illustrated. The engine system 100 includes a spark-ignition (SI) internal combustion engine 104 (hereinafter “engine 104”). The engine 104 is configured to draw air into an intake manifold 108 through an induction system 112 that is regulated by a throttle 116. The air in the intake manifold 108 is distributed to a plurality of cylinders 120 and combined with fuel to create an air/fuel mixture. The air/fuel mixture is compressed within the cylinders 120 by respective pistons (not shown) and the compressed air/fuel mixture is ignited by a sparking system 122. The sparking system 122 could be an inductive or capacitive discharge (CD) sparking system. In one implementation, the sparking system 122 includes spark plugs 124 that develop spark within their respective cylinders 120 in response to a current.

The ignition of the air/fuel mixture in a specific cylinder 120 causes a combustion event within the cylinder 120. More particularly, the combustion event drives the respective piston (not shown), which rotatably turns a crankshaft 128 to generate drive torque. An engine speed sensor 132 measures a rotational speed of the crankshaft 128 (engine speed). Camshafts 134a and 134b (collectively “camshafts 134”) control actuation of intake and exhaust valves (not shown) of the cylinders 120. A rotational offset between the camshafts 134 (also known as “camshaft overlap”) could result in internal EGR. More specifically, a portion of the exhaust gas remains in the cylinders 120 for subsequent cylinder combustion events. As previously mentioned, this is alternatively referred to as internal dilution. In one implementation, the camshafts 134 are dual overhead camshafts with a two-stage feature for low-lift and high-lift. It should be appreciated, however, that the engine 104 could include a single camshaft, such as a single overhead camshaft or a single camshaft in a pushrod configuration.

Exhaust gas resulting from combustion is expelled from the cylinders 120 into an exhaust system 136 that treats the exhaust gas before releasing it into the atmosphere. The exhaust gas in the exhaust system 136 is also recirculated into the intake manifold 108 via an external EGR system 140. In one exemplary implementation, the external EGR system includes an EGR pipe 144 that is regulated by an EGR valve 148 and the sparking system 122 includes ignition coils 152 that are configured to provide the current to the respective spark plugs 124. The sparking system 122 also includes, in one exemplary implementation, transistors (IGBT, Darlington, etc.) configured to control the flow of current from the ignition coils 152 to the spark plugs 124. While a controller 160 is described as controlling the sparking system 122, it should be appreciated that the sparking system 122 includes, in one implementation, its own controller.

In one implementation, the current is a waveform representing single strike engine ignition or multi-strike engine ignition. One example of the ignition coils 152 is low-impedance ignition coils configured for fast discharging/recharging. These low-impedance ignition coils are low to medium energy coils that are configured to discharge/recharge faster than high-impedance ignition coils that are typically high energy coils and discharge/recharge slower. The lower currents from low-impedance ignition coils decrease erosion to or do not erode the spark plugs 124, which thereby increases a life of the spark plugs 124.

The controller 160 controls the ignition coils 152. In one implementation, the controller 160 also controls the throttle 116, e.g., electronic throttle control (ETC), and fuel injectors (not shown). The controller 160 receives measurements from various sensors of the engine system 100, such as the engine speed from the engine speed sensor 132. The controller 160 also interacts with a driver interface 170. In one exemplary implementation, the driver interface 170 includes driver-actuated devices, such as an ignition actuator 174. Examples of the ignition actuator 174 include a key ignition and a push-button ignition. Actuation of the ignition actuator 174 starts the engine 104, which is also known as an engine-on event.

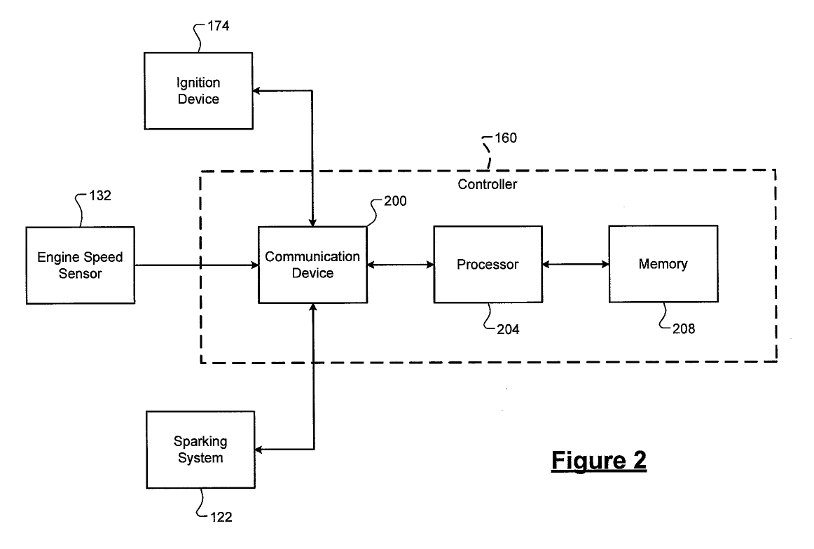

Referring now to FIG. 2, an example functional block diagram of the controller 160 is illustrated. The controller 160 includes a communication device 200, a processor 204, and a memory 208. It should be appreciated that the term “processor” as used herein refers to both a single processor and two or more processors operating in a parallel or distributed architecture. The memory 208 is any suitable storage medium (flash, hard disk, etc.) configured to store information at the controller 160.

The communication device 200 includes communication components, e.g., a transceiver, configured for communication with components of the engine system 100 via a controller area network (CAN). Specifically, the communication device 200 is configured to communicate with the engine speed sensor 132 to receive the engine speed and with the ignition coils 152 to command single strike or multi-strike engine ignition.

The processor 204 controls operation of the engine 104. Example functions performed by the processor 204 include loading/executing an operating system of the controller 160, controlling communication via the communication device 200, processing information received via the communication device 200 and the memory 208, and controlling read/write operations at the memory 208. The processor 204 also implements the multi-strike engine ignition techniques of the present disclosure, which are now described in greater detail. The processor 204 is configured to implement a multi-strike engine ignition technique. The multi-strike engine ignition technique involves controlling multi-strike ignition based on an amount of EGR and engine speed. The multi-strike engine ignition technique is also be referred to as optimized multi-strike engine ignition as discussed in greater detail herein.

The optimized multi-strike engine ignition technique is, in one exemplary implementation, configured to achieve a combustion metric target or a desired burn time. The burn time refers to a portion of the cylinder combustion event that the air/fuel mixture is burning. One goal of multi-strike engine ignition is faster and/or more robust initial flame development within the cylinders 120. One example of a desired burn time for the optimized multi-strike engine ignition technique is a 0-2% burn time. Another example of the desired burn time for the optimized multi-strike engine ignition technique is a 0-1% burn time. The faster burn times provide for improved combustion stability and, when multi-strike is precisely controlled, increased fuel efficiency.

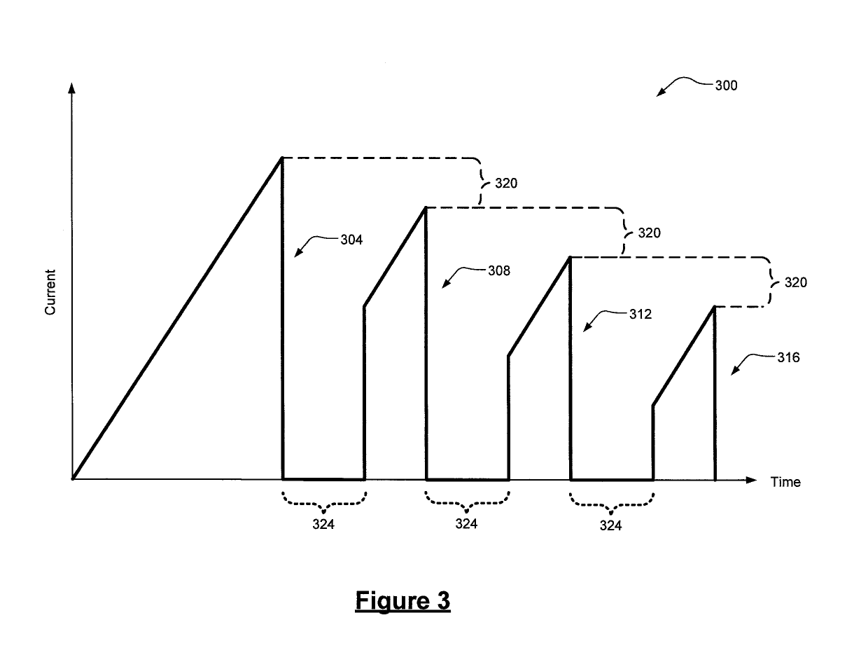

The optimized multi-strike engine ignition technique involves controlling various parameters for multi-strike ignition (hereinafter “multi-strike parameters”) based on the amount of EGR and the engine speed. FIG. 3 illustrates an example graph 300 of multi-strike ignition for a cylinder combustion event. A vertical axis of the graph 300 represents current (e.g., current through the primary sides of the ignition coils 152) and a horizontal axis of the graph 300 represents time. The illustrated time may be a burn time of a single cylinder combustion event. This multi-strike ignition includes a primary strike 304 followed by three re-strikes 308, 312, and 316, respectively. As shown, current magnitude decreases by a specific amount for each re-strike compared to a previous strike/re-strike. This is also referred to as a re-dwell percentage 320. In addition, each of the re-strikes is separated by a specific time 324.

Referring again to FIG. 2, in one implementation, the multi-strike parameters include (i) the number of re-strikes, (ii) the re-dwell percentage 320, and (iii) the time 324 between re-strikes. It should be appreciated that only one or two of these multi-strike parameters could be determined and utilized to control multi-strike engine ignition. Further, it should be appreciated that additional multi-strike parameters could be determined and utilized to control multi-strike engine ignition, such as parameters of the primary strike. As previously mentioned, each of these multi-strike parameters could be determined based on the amount of EGR and the engine speed.

The amount of EGR includes external EGR and/or internal EGR, depending on a configuration and operation of the engine 104. In one exemplary implementation, the amount of EGR is a percentage, e.g., a cooled EGR percentage. If applicable, the amount of external EGR is calculated, in one implementation, based on engine operating parameters such as position of the EGR valve 148. If applicable, the amount of internal EGR (or internal dilution) is calculated, in one implementation, based on engine operating parameters, such as camshaft overlap as previously discussed herein. The engine speed is determined using the engine speed sensor 132. The amount of EGR and the engine speed are then used by the processor 204 to determine the multi-strike parameters.

In one implementation, the processor 204 utilizes one or more three-dimensional look-up tables to determine the multi-strike parameters. Inputs include the amount of EGR and the engine speed and the output includes a specific multi-strike parameter. In one implementation, three different three-dimensional look-up tables are used to determine (i) the number of re-strikes, (ii) the re-dwell percentage 320, and (iii) the time 324 between re-strikes, respectively. These three-dimensional look-up tables are generated, for example, using predetermined engine dynamometer training data, and are stored at the memory 208 to be accessed and utilized by the processor 204 to determine the corresponding multi-strike parameters.

The processor 204 controls multi-strike engine ignition based on (i) the number of re-strikes, (ii) the re-dwell percentage 320, and (iii) the time 324 between re-strikes. In one implementation, this includes controlling the sparking system 122 based on these multi-strike parameters to improve combustion stability, decrease BSFC, and/or decrease/prevent erosion of the spark plugs 124. For example, this includes generating control signals for the ignition coils 152 that cause the ignition coils 152 to generate current waveforms corresponding to the determined multi-strike parameters. For example only, the current waveforms are the same or similar to the current waveform illustrated in FIG. 3. The primary current waveforms generated by the ignition coils 152 are provided to the spark plugs 124, which cause the spark plugs 124 to develop multiple sparks per cylinder combustion event.

Therefore, when appropriate (according to the three-dimensional look-up tables), the controller 160 performs multi-strike engine ignition to achieve improved combustion stability and increased fuel economy. At certain engine operating conditions, however, the three-dimensional look-up tables may indicate single strike engine ignition. For example, single strike engine ignition is appropriate for engine operating conditions such as low EGR and/or high engine speed. In other words, the controller 160 determines whether to perform multi-strike engine ignition (and if so, how to control it) by using the three-dimensional look-up tables.

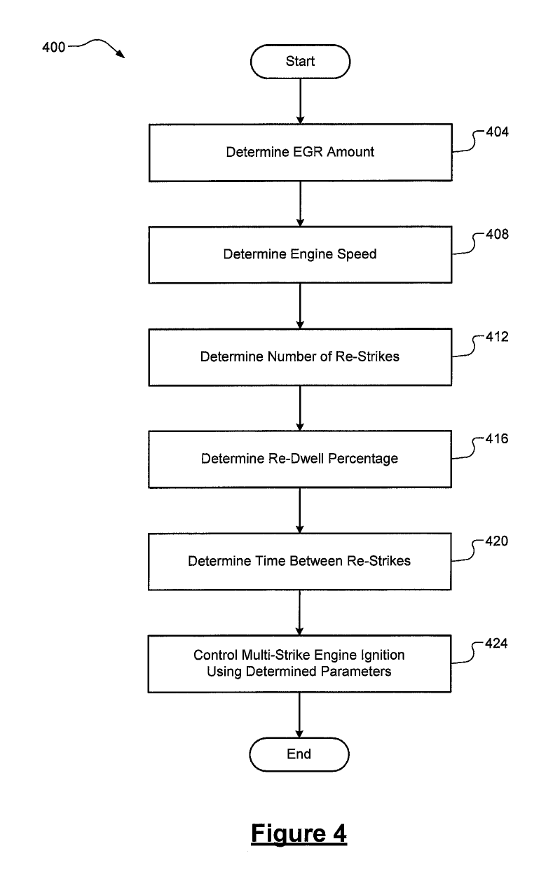

Referring now to FIG. 4, an example flow diagram of a multi-strike engine ignition method 400 is illustrated. At 404, the controller 160 determines an amount of EGR for the engine 104. In one implementation, the amount of EGR includes external EGR and/or internal EGR (internal dilution), e.g., based on the camshaft overlap. At 408, the controller 160 determines the engine speed. At 412, the controller 160 determines a number of ignition coil re-strikes per cylinder combustion event for multi-strike engine ignition based on the amount of EGR and the engine speed. At 416, the controller 160 determines a re-dwell percentage for ignition coil re-strikes based on the amount of EGR and the engine speed. At 420, the controller 160 determines timing(s) between the ignition coil re-strikes based on the amount of EGR and the engine speed. At 420, the controller 160 controls multi-strike engine ignition by controlling the sparking system 122 based on (i) the number of ignition coil re-strikes, (ii) the re-dwell percentage 320, and (iii) the timing 324 between the ignition coil re-strikes. The method 400 then ends or returns to 404 for one or more additional cycles.

It should be understood that the mixing and matching of features, elements, methodologies and/or functions between various examples is expressly contemplated herein so that one skilled in the art would appreciate from the present teachings that features, elements and/or functions of one example are incorporated into another example as appropriate, unless described otherwise above.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

What is claimed is:

1. A method, comprising:
determining, at a controller for an internal combustion engine, the controller having one or more processors, an amount of exhaust gas recirculation (EGR) for the engine;
determining, at the controller, a speed of the engine;
determining, at the controller, a number of re-strikes of ignition coils per cylinder combustion event for multi-strike engine ignition based on the amount of EGR and the engine speed;
determining, at the controller, a re-dwell percentage for ignition coil re-strikes based on the amount of EGR and the engine speed;
determining, at the controller, a timing between the ignition coil re-strikes based on the amount of EGR and the engine speed; and
controlling, by the controller, multi-strike engine ignition by controlling a sparking system of the engine based on (i) the number of ignition coil re-strikes, (ii) the re-dwell percentage, and (iii) the timing between the ignition coil re-strikes.

2. The method of claim 1, wherein the number of ignition coil re-strikes is between zero and five, inclusive.

3. The method of claim 1, wherein the number of ignition coil re-strikes, the re-dwell percentage, and the timing between the ignition coil re-strikes are determined based on the amount of EGR and the engine speed using three-dimensional look-up tables.

4. The method of claim 3, wherein different three-dimensional look-up tables are used to determine (i) the number of ignition coil re-strikes, (ii) the re-dwell percentage, and (iii) the timing between the ignition coil re-strikes.

5. The method of claim 1, wherein the amount of EGR includes at least one of (i) EGR via an external EGR system of the engine and (ii) internal EGR of the engine.

6. The method of claim 5, further comprising determining, at the controller, the internal EGR of the engine based on an overlap between camshafts of the engine.

7. The method of claim 1, wherein the ignition coils are low-impedance ignition coils configured for fast discharging/recharging.

8. The method of claim 1, wherein the sparking system of the engine includes the ignition coils and spark plugs.

9. The method of claim 8, wherein controlling the sparking system includes controlling the ignition coils based on (i) the number of ignition coil re-strikes, (ii) the re-dwell percentage, and (iii) the timing between the ignition coil re-strikes.

10. The method of claim 9, wherein controlling the ignition coils based on (i) the number of ignition coil re-strikes, (ii) the re-dwell percentage, and (iii) the timing between the ignition coil re-strikes causes the ignition coils to provide current waveforms to the spark plugs, and wherein the current waveforms cause the spark plugs to develop multiple sparks per cylinder combustion event.

11. An engine system, comprising:
an internal combustion engine having a plurality of cylinders configured to combust an air/fuel mixture to generate drive torque; and
a controller configured to:
determine amount of exhaust gas recirculation (EGR) for the engine;
determine a speed of the engine;
determine a number of re-strikes of ignition coils per cylinder combustion event for multi-strike engine ignition based on the amount of EGR and the engine speed;
determine a re-dwell percentage for ignition coil re-strikes based on the amount of EGR and the engine speed;
determine a timing between the ignition coil re-strikes based on the amount of EGR and the engine speed; and
control multi-strike engine ignition by controlling a sparking system based on (i) the number of ignition coil re-strikes, (ii) the re-dwell percentage, and (iii) the timing between the ignition coil re-strikes.

12. The engine system of claim 11, wherein the number of ignition coil re-strikes is between zero and five, inclusive.

13. The engine system of claim 11, wherein the controller is configured to determine each of the number of ignition coil re-strikes, the re-dwell percentage, and the timing between the ignition coil re-strikes based on the amount of EGR and the engine speed using three-dimensional look-up tables.

14. The engine system of claim 13, wherein the controller is configured to use different three-dimensional look-up tables to determine (i) the number of ignition coil re-strikes, (ii) the re-dwell percentage, and (iii) the timing between the ignition coil re-strikes.

15. The engine system of claim 11, wherein the amount of EGR includes at least one of (i) EGR via an external EGR system of the engine and (ii) internal EGR of the engine.

16. The engine system of claim 15, further comprising determining the internal EGR of the engine based on an overlap between camshafts of the engine.

17. The engine system of claim 11, wherein the ignition coils are low-impedance ignition coils configured for fast discharging/recharging.

18. The engine system of claim 11, further comprising the sparking system, wherein the sparking system includes the ignition coils and spark plugs.

19. The engine system of claim 18, wherein the controller is configured to control the sparking system by controlling the ignition coils based on (i) the number of ignition coil re-strikes, (ii) the re-dwell percentage, and (iii) the timing between the ignition coil re-strikes.

20. The engine system of claim 19, wherein controlling the ignition coils based on (i) the number of ignition coil re-strikes, (ii) the re-dwell percentage, and (iii) the timing between the ignition coil re-strikes causes the ignition coils to provide current waveforms to the spark plugs, and wherein the current waveforms cause the spark plugs to develop multiple sparks per cylinder combustion event.
